(19) United States
(12) Patent Application Publication
(10) Pub. No.: US 2008/0185868 A1
(43) Pub. Date: Aug. 7, 2008

(54) Process for Actuating a Vehicle Door of a Motor Vehicle

(75) Inventors: Michael Hubmann, Bad Rappenau (DE); Thomas Hagel, Korntal-Muenchingen (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 12/027,298

(22) Filed: Feb. 7, 2008

(30) Foreign Application Priority Data
Feb. 7, 2007 (DE) 102007 006 030.2

(51) Int. Cl. E05F 15/20

(52) U.S. Cl. 296/146.1

(57) ABSTRACT

A process for actuating a vehicle door of a motor vehicle includes the steps of automatically closing the vehicle door of the motor vehicle by a drive at a specified closing speed upon initiation of a closing command and performing a check to verify that the vehicle door is properly closed at an end of a closing process with the specified closing speed. If it is determined that the vehicle door is properly closed, the specified closing speed remains unchanged for at least one subsequent closing process. If it is determined that the vehicle door is not properly closed, the specified closing speed is increased for at least one subsequent closing process.

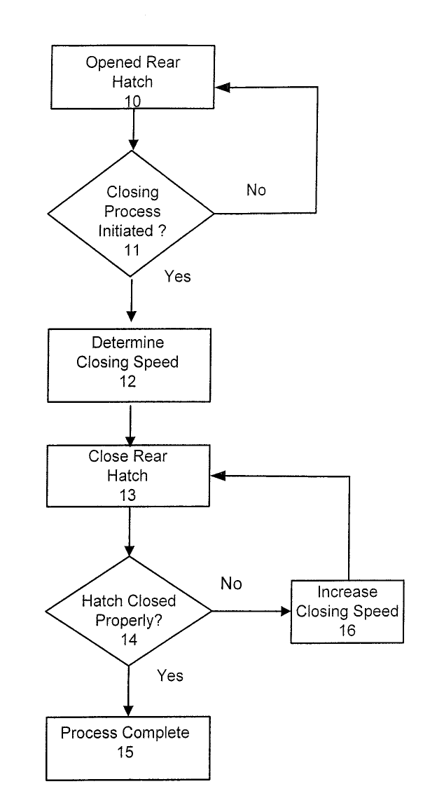

### CROSS-REFERENCE TO RELATED APPLICATION

This application claims the priority, under 35 U.S.C. § 119, of German application DE 10 2007 006 030.2, filed Feb. 7, 2007; the prior application is herewith incorporated by reference in its entirety.

### BACKGROUND OF THE INVENTION

### Field of the Invention

This invention concerns a process for actuating a vehicle door of a motor vehicle.

From published, non-prosecuted German patent application DE 101 17 935 A1 (corresponding to U.S. patent publication No. 20040090083 A1), a process for actuating a vehicle door of a motor vehicle is known, whereby a speed with which the vehicle door is swiveled between two positions is metrologically recorded and where the determined actual speed of the vehicle door is compared with a setpoint curve, and where the closing speed of the vehicle door is adjusted to an angle-dependent target value.

### SUMMARY OF THE INVENTION

It is accordingly an object of the invention to provide a process for actuating a vehicle door of a motor vehicle that overcomes the above-mentioned disadvantages of the prior art methods of this general type.

According to the invention, the process contains at least the following steps: a) initiated by a closing command, the vehicle door of the motor vehicle is closed automatically by a drive at a specified closing speed; b) at the end of the closing process with the specified speed, a check is performed to verify that the vehicle door is properly closed; and c) if it is determined that the vehicle door is properly closed, then the specified closing speed remains unchanged for at least one subsequent closing process. However, if it is determined that the vehicle door is not properly closed, the closing speed is increased above the specified closing speed for at least one subsequent closing process.

In terms of the process according to the invention, a check is performed after completion of a closing process to verify that the vehicle door to be closed is properly closed. If it is determined that the vehicle door is not properly closed, then the closing speed of the vehicle door is increased for at least one subsequent closing process in order to ensure proper closing of the vehicle door during the subsequent closing process.

The present invention relates to a process for actuating a vehicle door of a motor vehicle, namely for automated closing of a vehicle door, in particular of a rear hatch.

In accordance with an added mode of the invention, there is the step of closing the vehicle door by an electro-hydraulic device, an electromechanical device, or an electromotive device.

In accordance with a further mode of the invention, the is the step of checking whether a closing element of the vehicle door has properly latched into a latching device of a fixed body part adjacent to the vehicle door at an end of the closing process at the specified closing speed.

Other features which are considered as characteristic for the invention are set forth in the appended claims.

Although the invention is illustrated and described herein as embodied in a process for actuating a vehicle door of a motor vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The single FIGURE of the drawing is a signal flow diagram for describing a process of a preferred application of closing a rear hatch according to the invention.

### DETAILED DESCRIPTION OF THE INVENTION

Referring now to the single FIGURE of the drawing in detail, there is shown in a first step 10 of a process according to the invention, an opened rear hatch of a motor vehicle.

In the following step 11, it is checked, whether, for example, a closing process of the rear hatch is initiated by a driver or another person. If it is determined in step 11 that no closing process is initiated, then one reverts to step 10. However, if it is determined in step 11 that a closing command exists, then one proceeds from step 11 to step 12.

In step 12, a specified closing speed for the closing command and thus for the subsequent closing process to be performed, which is stored in the vehicle electronics, is then determined, with which the closing process for closing of the rear hatch is subsequently performed.

After determination of the specified closing speed in accordance with step 12, the closing of the rear hatch is performed automatically in a subsequent step 13 with this determined specified closing speed. This automated execution of the closing process can be done by various measures, for example electro-hydraulically (electric motor+hydraulic pump), electro-mechanically (electric motor+gearbox) or also by an electromotive device (directly through an electric motor).

At the end of the closing process at the specified closing speed, in step 14 of the process according to the invention it is checked whether the rear hatch is closed properly. On this occasion it is preferably checked whether a closing element of the moveable rear hatch has properly latched into a latching device of the fixed body part adjacent to the rear hatch. If it is determined in step 14 that the rear hatch is closed properly, then the process proceeds from step 14 to step 15, and the closing process is completed. The specified closing speed will remain unchanged for at least one subsequent closing process.

However, if it is determined in step 14 that the rear hatch is not properly closed, then the process proceeds from step 14 to step 16 and the closing speed will be increased compared to the closing speed specified for the preceding closing process for at least one subsequent closing process. Thereafter, the process proceeds to step 13, and the closing process for the rear hatch is repeated with this increased closing speed.

Accordingly, in terms of the present invention, a subsequent closing process is then performed at an increased closing speed if a closing error has been detected after the completion of the closing process. The increased closing speed can be either stored as a specified quantity in the vehicle electronics, or alternatively, a difference speed can also be stored in the vehicle electronics, by which the specified closing speed is increased after a closing error has been detected.

1. A process for actuating a vehicle door of a motor vehicle, which comprises the steps of:
automatically closing the vehicle door of the motor vehicle by a drive at a specified closing speed upon initiation of a closing command;
performing a check to verify that the vehicle door is properly closed at an end of a closing process with the specified closing speed;
keeping the specified closing speed to remain unchanged for at least one subsequent closing process if it is determined that the vehicle door is properly closed; and
increasing the specified closing speed for at least one subsequent closing process if it is determined that the vehicle door is not properly closed.

2. The process according to claim 1, which further comprises closing the vehicle door by one of an electro-hydraulic device, an electromechanical device, and an electromotive device.

3. The process according to claim 1, which further comprises checking whether a closing element of the vehicle door has properly latched into a latching device of a fixed body part adjacent to the vehicle door at an end of the closing process at the specified closing speed.
